(19) United States
(12) Patent Application Publication
(10) Pub. No.: US 2007/0273935 A1
(43) Pub. Date: Nov. 29, 2007

(54) Image Reading Apparatus, MFP, and Document Detecting Method

(75) Inventors: Naoaki Ide, Shizuoka-Ken (JP); Yusuke Hashizume, Chiba-Ken (JP); Hirokazu Shoda, Kangawa-Ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/420,197

(22) Filed: May 24, 2006

(51) Int. Cl. H04N 1/04

(52) U.S. Cl. 358/474

(57) ABSTRACT

An MFP includes a scanner to read an image, and a printer to form the image on a sheet, in which the scanner includes a document table on which a document as an image reading object is placed, a platen cover that holds the document to the document table, a carriage that moves along the document table, a document size detecting element that detects a size of the document at a position in front of an image reading start position of the document in an image reading direction, and a control device that detects the document size based on an output of the document size detecting element. According to the MFP, it is possible to realize shortening of an image reading time while reduction in thickness of the apparatus and reduction in cost are kept.

### BACKGROUND OF THE INVENTION

1. Field of the Invention

The present invention relates to an image reading apparatus, an MFP (Multi Function Peripherals) and a document detecting method, and particularly to an image reading apparatus, an MFP and a document detecting method in which detection of a document size can be performed at the time of image reading.

2. Related Art

In an image reading apparatus used in a conventional MFP (Multi Function Peripherals) or the like, as disclosed in JP-A-11-225234 (patent document 1), a document detecting sensor is fixed at a specified position below a document mounting table and to a base of a scanner, so that the detection of a document size is performed based on a result of detection of the presence/absence of a document. Incidentally, the document detecting element includes a reflective photosensor.

However, in the image reading apparatus disclosed in patent document 1, the reflective photosensor is used as the document size detecting element (APS sensor), and plural ones are arranged at suitable positions of the scanner base, so that the detection is performed.

With the progress of reduction in thickness of a scanner and reduction in cost in recent years, it has become a bad effect that the reflective photosensor is large and the cost is relatively high. Besides, in the case where the reflective photosensor is used, there are problems that the detection can not be performed in the state where a platen cover is closed, it is necessary to take measures against the influence of external light, there is a document with a color which can not be detected, and so on.

As disclosed in Japanese Patent No. 2924751 (patent document 2), an image reading apparatus for detecting a document size by using a CCD sensor is also proposed.

As a method of detecting the document size by using the CCD sensor, there is a method of detecting the document size as a reading object of an image by pre-scanning. Besides, in the case where the pre-scanning is not used, there is a method in which the document size is detected after the document is read in largest document size.

However, in the case where the document size is detected by using the CCD sensor, the pre-scanning is required before the image reading, and there is a defect that a reading time is additionally required by the execution of the pre-scanning.

Besides, although there is a method of detecting the document size without performing the pre-scanning, in this case, a page memory once captures a read image, and then, the document size is recognized, and therefore, a time required until the image is copied on a sheet with a suitable size and paper discharge is performed becomes long similarly to the case where the pre-scanning is performed.

Further, since the reading of an image is always performed in the image readable range of the largest size, there is a disadvantage that even in a small document, a reading time of an image becomes equal to that in the case where an image of a document with the largest size is read.

Then, there are desired an image reading apparatus, an MFP and a document detecting method in which an image reading time is shortened while reduction in thickness of the apparatus and reduction in cost are kept.

### SUMMARY OF THE INVENTION

The invention has been made in view of the above circumstances, and has an object to provide an image reading apparatus, an MFP and a document detecting method in which an image reading time is shortened while reduction in thickness of the apparatus and reduction in cost are kept.

In order to achieve the object, an image reading apparatus of the invention includes a document table on which a document as an image reading object is placed, a platen cover that holds the document to the document table, a carriage that moves along the document table, a document size detecting light-emitting element that emits light when a size of the document is detected, a document size detecting light-receiving element that receives the light emitted from the document size detecting light-emitting element, and a control device that detects the document size based on an output of the document size detecting light-receiving element.

In order to achieve the object, an image reading apparatus of the invention and an MFP includes a scanner to read an image, and a printer to form the image on a sheet, in which the scanner includes a document table on which a document as an image reading object is placed, a platen cover that holds the document to the document table, a carriage that moves along the document table, a document size detecting light-emitting element that emits light when a size of the document is detected, a document size detecting light-receiving element that receives the light emitted from the document size detecting light-emitting element, and a control device that detects the document size based on an output of the document size detecting light-receiving element.

In order to solve the object, a document detecting method comprising the steps of: detecting whether a document is placed on a document table; and detecting a size of the document, wherein said document presence/absence detection step and the document size detection step are performed before image reading when a carriage is moved to perform the image reading of the document.

Accordingly, according to the image reading apparatus, the MFP and the document detecting method of the invention, the shortening of the image reading time can be realized while the reduction in thickness of the apparatus and the reduction in cost are kept.

### BRIEF DESCRIPTION OF THE DRAWINGS

In the accompanying drawings:

FIG. 1 is a view schematically showing a structural example of an MFP of a first embodiment of the invention;

FIG. 2 is a view schematically showing a structural example of a scanner of the MFP of the first embodiment of the invention;

FIG. 3 is a functional block diagram of the MFP of the first embodiment of the invention;

FIG. 4A is a view showing an arrangement example of light-emitting APS sensors and a document presence/absence detecting light-emitting element seen from the rear side of a platen cover in the scanner of the MFP of the first embodiment of the invention;

FIG. 4B is a view showing an arrangement example of document size detecting light-receiving elements and a document presence/absence detecting light-receiving element seen from the upper (document table glass) side in the scanner of the MFP of the first embodiment of the invention;

FIG. 5 is a view showing another arrangement example of light-emitting APS sensors and document presence/absence detecting light-emitting elements seen from the rear side of the platen cover in the MFP of the first embodiment of the invention;

FIG. 6 is a view showing a relation between a document size (for example, AB series document size) and a light receiving position of a document size detecting light-receiving element in the MFP of the first embodiment of the invention;

FIG. 7 is a table showing a relation between ON/OFF of a light-receiving APS sensor to receive the light from the light-emitting APS sensor shown in FIG. 6 and a document size;

FIG. 8 is a view (timing chart) showing timing of document size detection in the MFP of the first embodiment of the invention;

FIG. 9 is a view showing a structural example of a first carriage in which a light shielding unit is placed around the light-receiving APS sensor in the scanner of the MFP of the first embodiment of the invention;

FIG. 10 is a view schematically showing a structural example of a scanner of an MFP of a second embodiment of the invention;

FIG. 11 is a functional block diagram of the MFP of the second embodiment of the invention;

FIG. 12A is a view showing an arrangement example of light-receiving APS sensors and a document presence/absence detecting light-receiving element seen from the rear side of a platen cover in a scanner of the MFP of the second embodiment of the invention;

FIG. 12B is a view showing an arrangement example of document size detecting light-emitting elements and a document presence/absence detecting light-emitting element seen from the upper (document table glass) side in the scanner of the MFP of the second embodiment of the invention;

FIG. 13 is a view showing another arrangement example of light-receiving APS sensors and a document presence/absence detecting light-receiving element seen from the rear side of the platen cover in the MFP of the second embodiment of the invention;

FIG. 14 is a view (timing chart) showing timing of document size detection in the MFP of the second embodiment of the invention;

FIG. 15 is a view showing an example in which a line light source is used as the document size detecting light-emitting element and the document presence/absence detecting light-emitting element in the scanner of the MFP of the second embodiment of the invention;

FIG. 16 is a view for explaining how to detect the inclination of a document in a scanner of an MFP of a third embodiment of the invention; and

FIG. 17 is a view schematically showing a structural example of a control device in the scanner of the MFP of the third embodiment of the invention.

### DETAILED DESCRIPTION OF THE PREFERRED EMBODIMENTS

Embodiments of an image reading apparatus, an MFP (Multi Function Peripherals) and a document detecting method of the invention will be described with reference to the drawings.

Incidentally, directions of up and down, right and left, front and rear, and the like disclosed in the present specification are based on an illustrated state or a normal apparatus use state, unless particularly described otherwise.

### First Embodiment

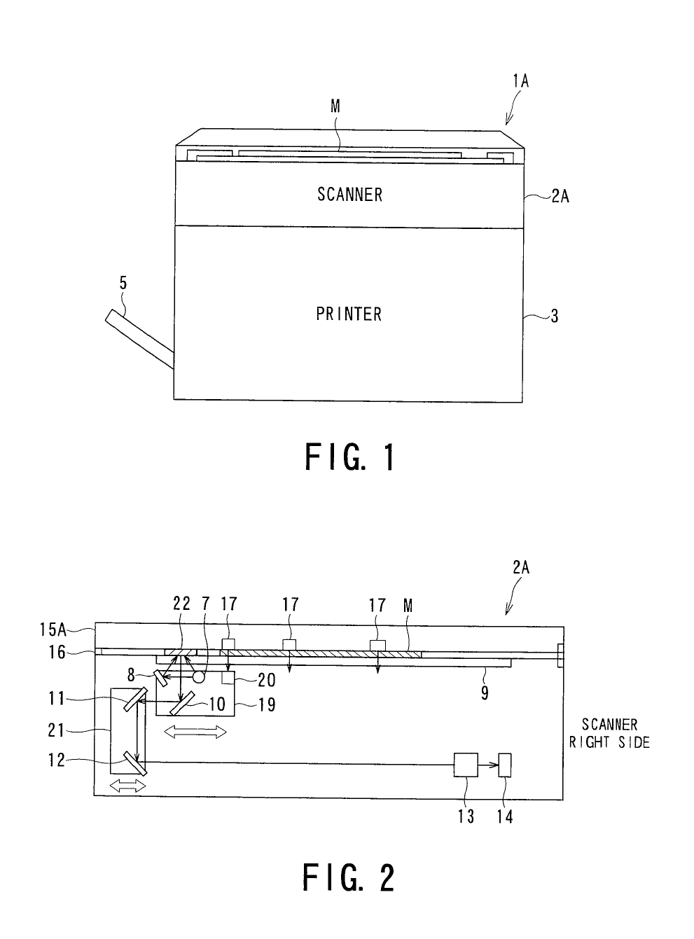

FIG. 1 is a view schematically showing a structure of an MFP 1A as an example of an MFP of a first embodiment of the invention.

The MFP 1A includes a scanner 2A to read an image and a printer 3 to form the image on a sheet.

The scanner 2A scans a positioned document M to read the image and reads the image of the document M. In the case where the read image is formed, the scanner 2A transmits the information of the read image to the printer 3.

The printer 3 forms the image on the sheet based on the information of the image to be formed, and then outputs the sheet on which the image has been formed to a paper discharge tray 5.

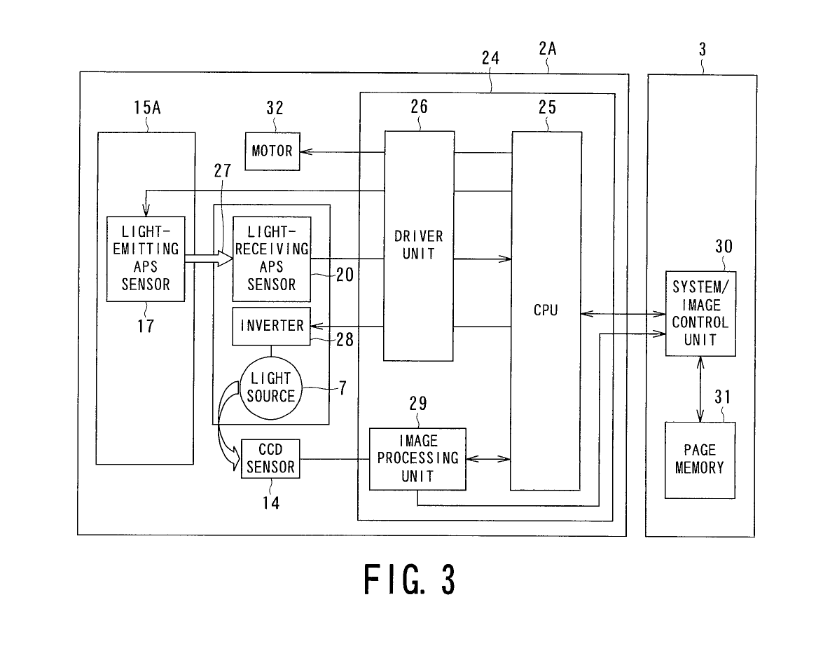

Incidentally, although the image copying apparatus (the MFP) 1A further includes a system controller (see FIG. 3 described later) to perform a control and a control panel (see FIG. 3 described later) as a user interface, they are omitted in FIG. 1.

FIG. 2 is a view schematically showing a structure of the scanner 2A as an example of a scanner of the MFP of the first embodiment of the invention.

In the scanner (image reading apparatus) 2A, a light irradiated from a light source (for example, a xenon lamp) 7 and a light irradiated from the light source 7 and reflected by a reflector 8 are irradiated to the document M positioned on a document table glass 9, and the reflected light is imaged onto a CCD sensor 14 as an example of a photoelectric element by a condensing lens 13 through a first mirror 10, a second mirror 11 and a third mirror 12.

The document M is fixed on the document table glass 9 by a document table cover (platen cover) 15. The open/close state of the platen cover 15A is detected by ON/OFF of a platen cover open/close switch 16. In the platen cover 15A, APS sensors (hereinafter referred to as light-emitting APS sensors) 17 as document size detecting light-emitting elements that emit lights when a document size is detected are arranged at specified positions on the rear surface (document table glass 9) side.

The xenon lamp 7 as an example of the light source, an inverter (not shown in FIG. 2) to drive the xenon lamp 7, the reflector 8, and the first mirror 10 are arranged in a first carriage 19.

In the first carriage 19, light-receiving APS sensors 20 that receive the lights of the light-emitting APS sensors 17 are arranged at a document surface side (upper side shown in FIG. 2) and at a front side in an image reading direction (right side shown in FIG. 2). That is, the light-receiving APS sensors 20 are arranged at the positions where the lights of the light-emitting APS sensors 17 can be received at the front side in the image reading direction before the image reading of the document M is started.

The second mirror 11 and the third mirror 12 are arranged in a second carriage 21.

A shading correction plate (white reference plate) 22 which becomes a reference when shading correction is performed is provided on the document table glass 9.

Incidentally, in the MFP 1 shown in FIG. 2, there is also a case where instead of the platen cover 15A, a not-shown automatic document feeder (ADF) is mounted, and an image of a document is read from the ADF.

Next, the operation of the MFP 1A will be described.

FIG. 3 is a functional block diagram of the MFP 1A.

The MFP 1A includes the scanner 2A, the printer 3 and a control device 24 to control the whole system. The control device 24 includes a CPU (Central Processing Unit) 25 to perform various arithmetic processes, and a driver unit 26 to drive an equipment such as the light-emitting APS sensor 17.

In the MFP 1A, at the time of image reading of the document M, first, the CPU (Central Processing Unit) 25 controls the driver unit 26, and the driver unit 26 drives the light-emitting APS sensor 17 arranged at the rear side of the platen cover 15A and controls a light emitting operation. At this time, the first carriage 19 and the second carriage 21 stand by at a scan origin position (home position).

A light 27 emitted from the light-emitting APS sensor 17 is received by the light-receiving APS sensor 20 arranged in the first carriage 19. An output signal of the light-receiving APS sensor 20 is captured by the CPU 25 through the driver unit 26. Further, with respect to the light source 7 arranged in the first carriage 19, the CPU 25 controls the driver unit 26 and the driver unit 26 controls an inverter 28 so that light emitting control is performed.

The light 27 irradiated from the light source 7 is reflected by the document surface, is condensed by the condensing lens 13 through the first mirror 10, the second mirror 11 and the third mirror 12, and is imaged onto the CCD sensor 14.

The output (image output) of the CCD sensor 14 is subjected to a signal processing such as A/D conversion and shading correction by an image processing unit 29. The image output subjected to the signal processing is outputted as image data to the printer 3, and is inputted to a system/image control unit 30 of the printer 3. The image processing unit 29 and the system/image control unit 30 are controlled by the CPU 25.

The image data inputted to the system/image control unit 30 is once stored in a page memory 31, and then, an image processing is performed. Further, the system/image control unit 30 communicates with an external device not shown in FIG. 1.

The CPU 25 controls the driver unit 26 and the driver unit 26 drives a motor 32 as an example of a drive device so that the first carriage 19 and the second carriage 21 are moved.

In order to read the image of the whole surface of the document M, the first carriage 19 is made to scan under the document M. When the image of the whole surface of the document M is read, the second carriage 21 relatively scans at a speed of ½ of the speed of the first carriage 19, and the light path length from the document surface to the CCD 14 is always kept constant.

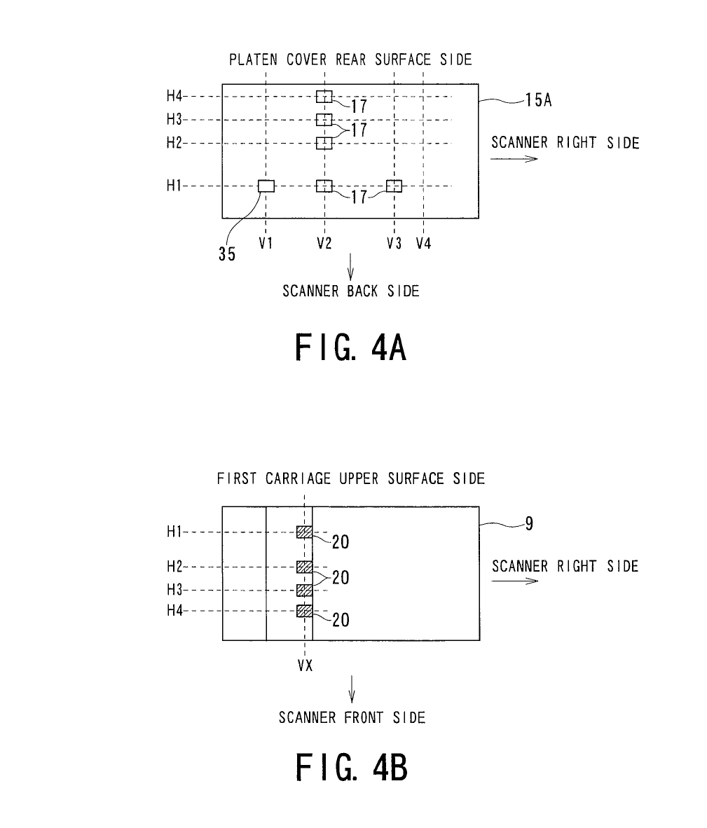

FIG. 4A and FIG. 4B are views showing an example in which the document size detecting light-emitting elements, the document presence/absence detecting light-emitting element, the document size detecting light-receiving elements, and the document presence/absence detecting light-receiving element are mounted in the MFP 1A.

In more detail, FIG. 4A is an arrangement view of the light-emitting APS sensors 17 and a document presence/absence detecting light-emitting element 35 seen from the rear side of the platen cover 15A, and FIG. 4B is an arrangement view of the light-receiving APS sensors 20 as the document size detecting light-receiving elements and the document presence/absence detecting light-receiving element in the case seen from the upper (document table glass 9) side.

Here, H1 to H4 indicated in FIG. 4A and FIG. 4B denote positions in the main scanning direction (vertical direction in FIG. 4A and FIG. 4B). Further, V1 to V4 indicated in FIG. 4A and VX indicated in FIG. 4B denote positions in the sub-scanning direction (horizontal direction in FIG. 4A and FIG. 4B). Furthermore, in the following description, intersections between V1 to V4 and H1 to H4 are denoted by VnHm (n and m is one of 1, 2, 3 and 4), and intersections between VX and H1 to H4 are denoted by VXHn (n is one of 1, 2, 3 and 4).

As shown in FIG. 4A, the light-emitting APS sensors 17 to emit lights are arranged at V2H1, V2H2, V2H3, V2H4 and V3H1 on the rear surface of the platen cover 15. Further, the document presence/absence detecting light-emitting element 35 to emit light at the time of document detection is arranged at a position of V1H1.

In addition, in the MFP 1A, transmission sensors (thrubeam type sensors) are used as the light-emitting APS sensors 17 and the document presence/absence detecting light-emitting element 35. Accordingly, the light-emitting element 35 at V1H1 shown in FIG. 4A and the light-receiving elements 20 at VXH1 shown in FIG. 4B, the light-emitting elements 17 at V2H1, V2H2, V2H3 and V2H4 shown in FIG. 4A and the light-receiving elements 20 at VXH1, VXH2, VXH3 and VXH4 shown in FIG. 4B, and the light-emitting element 17 at V3H1 of FIG. 4A and the light-receiving element 20 at VXH1 shown in FIG. 4B are paired with each other.

Since all of the light-emitting APS sensors 17, the light-receiving APS sensors 20, and the document presence/absence detecting light-emitting element 35 are the transmission sensors, unlike the reflection sensor (reflection type sensor), even if the document M as the reading object of the image has a high density, erroneous detection does not occur, and the presence/absence of the document M and the size can be certainly detected.

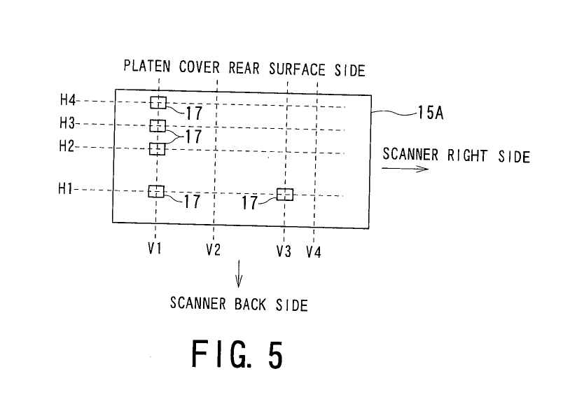

FIG. 5 is view showing another (different from the example shown in FIG. 4A) example in which document size detecting elements and document presence/absence detecting elements in the MFP 1A are mounted, and is more particularly an arrangement view of the light-emitting APS sensors 17 seen from the rear side of the platen cover 15A.

Incidentally, in the another example shown in FIG. 5, as the mounting of document size detecting light-receiving elements and a document presence/absence detecting light-receiving element, the mounting example shown in FIG. 4B is applied. Further, H1 to H4, and V1 to V4 shown in FIG. 5 are the same as those of FIG. 4A.

As shown in FIG. 5, the light-emitting APS sensors 17 to emit lights are arranged at positions of V1H1, V1H2, V1H3 and V1H4 and a position of V3H1 on the rear side of the platen cover 15A.

A difference between the mounting example shown in FIG. 5 and the mounting example shown in FIG. 4A is that in the platen cover 15A shown in FIG. 5, the document presence/absence detecting light-emitting element 35 is not provided, and the positions where the light-emitting APS sensors 17 are arranged are changed.

In the platen cover 15A, by arranging the light-emitting APS sensors 17 at the positions shown in FIG. 5, when the first carriage 19 in which the light-emitting APS sensors 20 are provided is at the standby position (home position), the breadth (length in the main scanning direction) of the document M can be detected by the light-emitting APS sensors 17 at V1H1, V1H2, V1H3 and V1H4 and the light-receiving APS sensors 20 at VXH1, VXH2, VXH3 and VXH4 shown in FIG. 4B.

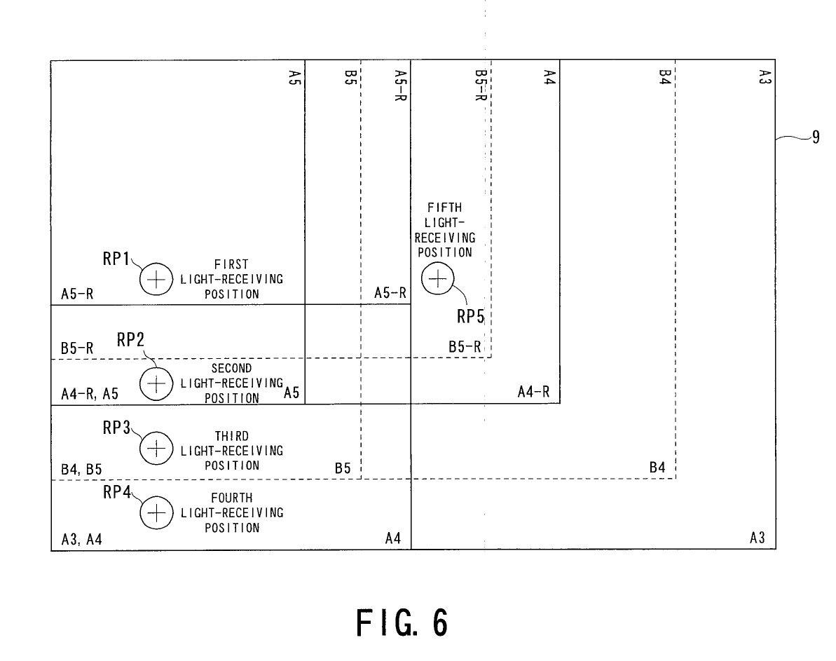

FIG. 6 is a view showing a relation between a document size (for example, AB series document size) and a light receiving position of the light-receiving APS sensor 20 in the case seen from the upper side of the first carriage 19.

Here, symbol RP1 indicated in FIG. 6 means a first light receiving position, and denotes the position of the light-receiving APS sensor 20 to receive the light emitted by the first light-emitting APS sensor 17A. Similarly, RP2 to RP5 mean a second light receiving position to a fifth light receiving position, respectively, and denote the positions of the light-receiving APS sensors 20 to receive the lights emitted by the second light-emitting APS sensors 17B.

In the case of the platen cover 15A shown in FIG. 4A, the first light-emitting APS sensor 17A to the fifth light-emitting APS sensor 17E shown in FIG. 6 emit lights at the positions of V2H1, V2H2, V2H3, V2H4 and V3H1, and the light-receiving APS sensors 20 provided in the first carriage 19 receive the lights.

That is, in the scanner 2A including the platen cover 15A shown in FIG. 4A and FIG. 4B, the light-emitting APS sensor 17 and the light-receiving APS sensor 20 paired with each other function as a document size detecting element to detect the size of the document M.

Further, in the case of the platen cover 15A shown in FIG. 5, the first light-emitting APS sensor 17A to the fifth light-emitting APS sensor 17E shown in FIG. 6 emit lights at the positions of V1H1, V1H2, V1H3, V1H4 and V3H1, and the light receiving sensors 20 provided in the first carriage 19 receive the lights.

That is, in the scanner 2A including the platen cover ISA shown in FIG. 5, the light-emitting APS sensor 17 and the light-receiving APS sensor 20 paired with each other function as a document presence/absence detecting element to detect the presence/absence of the document M and as the document size detecting element to detect the size of the document M.

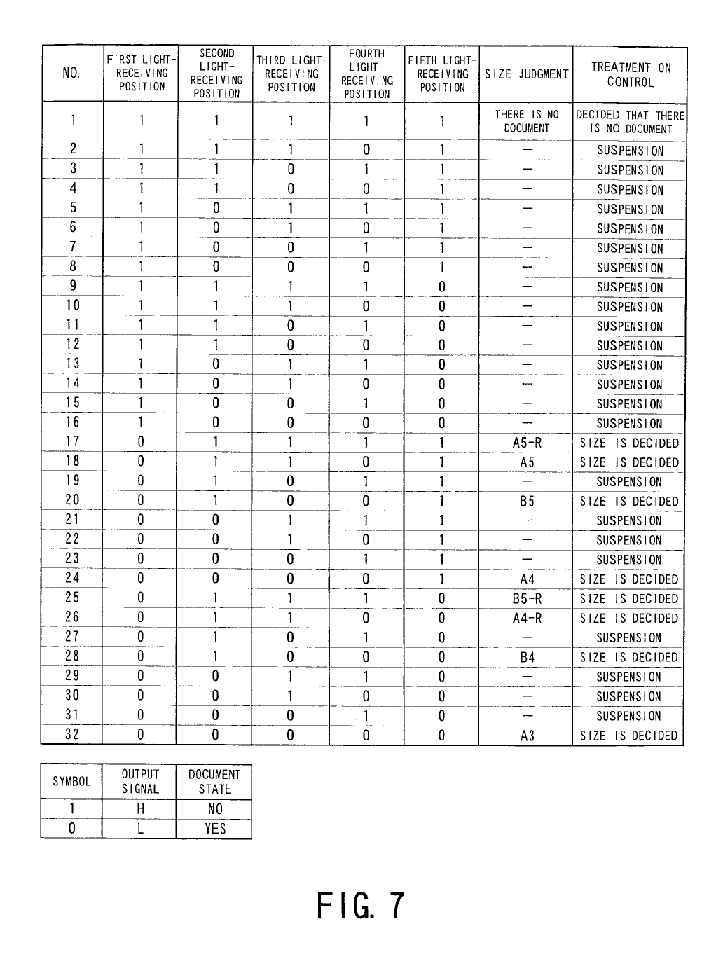

FIG. 7 is a table showing a relation between ON/OFF of the light-receiving APS sensor 20 to receive the light from the light-emitting APS sensor 17 shown in FIG. 6 and a document size.

For example, in the case where the A5-R document M is placed on the document table glass 9, this corresponds to the case of NO. 17 shown in FIG. 7. That is, the output of the light-receiving APS sensor 20 having received the light emitted from the first light-emitting APS sensor 17A is 0, the output of the light-receiving APS sensor 20 having received the light emitted from the second light-emitting APS sensor 17B is 1, the output of the light-receiving APS sensor 20 having received the light emitted from the third light-emitting APS sensor 17C is 1, the output of the light-receiving APS sensor 20 having received the light emitted from the fourth light-emitting APS sensor 17D is 1, and the output of the light-receiving APS sensor 20 having received the light emitted from the fifth light-emitting APS sensor 17E is 1.

Further, in the case where the A3 document is placed on the document table glass, this corresponds to the case of NO. 32 shown in FIG. 7. That is, the output of the light-receiving APS sensor 20 having received the light emitted from the first light-emitting APS sensor 17A is 0, the output of the light-receiving APS sensor 20 having received the light emitted from the second light-emitting APS sensor 17B is 0, the output of the light-receiving APS sensor 20 having received the light emitted from the third light-emitting APS sensor 17C is 0, the output of the light-receiving APS sensor 20 having received the light emitted from the fourth light-emitting APS sensor 17D is 0, and the output of the light-receiving APS sensor 20 having received the light emitted from the fifth light-emitting APS sensor 17E is 0.

Based on the light-emitting APS sensors 17A to 17E emitting the lights and the sensor outputs of the light-receiving APS sensors 20 as stated above, the CPU 25 shown in FIG. 3 performs an arithmetic processing, so that the size of the document M is detected.

Incidentally, in FIG. 4to FIG. 7, although the description has been given to the case where the document M has AB series of sizes, in the case of other sizes such as LT series of sizes, the light-emitting APS sensors 17 are arranged at positions where the LT series of sizes or the like can be detected.

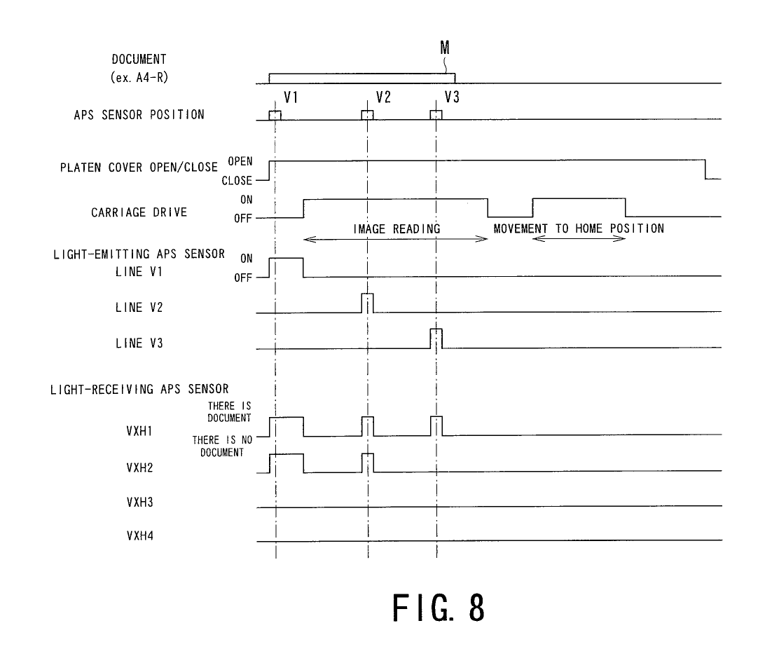

FIG. 8 is a view (timing chart) for explaining the timing of size detection of the document in the MFP 1A in which the horizontal axis is a time axis.

In FIG. 8, the description will be given to the case where the document M of A4-R size is placed on the document table glass 9, and the platen cover 15A has the structure shown in FIG. 4A.

When the user positions the document M on the document table glass 9 and closes the platen cover 15A, the document presence/absence detecting light-emitting element 35 at the position of V1H1 emits a light in order to detect the presence/absence of the document M. The emitted light is received by the light-receiving APS sensor 20 at the position of VXH1.

When the light-receiving APS sensor 20 receives the light emitted by the document presence/absence detecting light-emitting element 35, the CPU 25 detects the presence/absence of the document M based on the received light. In the case where the CPU 25 judges that the document does not exist, a subsequent processing (APS processing) is not carried out.

The detection of the size of the document M is performed such that the CPU 25 performs a control so that the document presence/absence detecting light-emitting element at the position of V1H1 is turned off in synchronization with the start of reading of the document M, and each of the light-emitting APS sensors 17B to 17E emits the light short of the paired light-receiving APS sensor 20 in synchronization with the operation of the carriages 19 and 21, and is turned off after passing.

For example, in the case of the document size A4-R, the light-receiving APS sensor 20 at the position of VXH1 detects the presence of the document at the positions of V2 and V3 during the image reading (there is no light reception), the light-receiving APS sensor 20 at the position of VXH2 detects the presence of the document (there is no light reception) at the position of V2 during the image reading, and the light-receiving APS sensors 20 at the positions of VXH3 and VXH4 do not detect the document M (there is light reception) at any positions of V2 and V3 during the image reading.

The size of the document M can be judged by the number of times of detection of the light-receiving APS sensors 20 moving to the positions corresponding to the respective light-emitting APS sensors 17A to 17E.

The first carriage 19 and the second carriage 21 are moved to the home position when the image reading is completed.

In the MFP 1A, since the transmission sensors are adopted as the sensors to detect the presence/absence of the document M and the size, the apparatus can be made thinner than the case where the reflection sensor is adopted, and even if the document M as the reading object of the image has a high density, erroneous detection does not occur, and the presence/absence of the document M and the size can be certainly detected.

Further, the presence/absence of the document M can be detected by using the light-emitting elements for size detection of the document M and the light-receiving elements without providing the sensor (document presence/absence detecting light-emitting element 35) for detecting the presence/absence of the document (see FIG. 5). Further, forgetting to take the document M can also be detected.

On the other hand, since light emission is controlled so that after passing through the light-receiving APS sensor 20, the light-emitting APS sensor 17 is turned off during the movement to the reading position of the image of the document M, the light emitted from the light-emitting APS sensor 17 can be prevented from entering the image reading position, and the erroneous detection of the document size can be prevented.

Further, since the image reading is carried out after the detection of the document size, the document size information is transmitted to the printer 3 before the image reading termination (completion of writing into the page memory 31), and the selection of a suitable paper size can be carried out on the printer 3 side.

Furthermore, since the light emitting side circuit is more inexpensive than the light receiving side circuit, by providing the light-emitting APS sensors 17 on the rear side of the platen cover 15A in which many elements are required, the inexpensive structure can be obtained.

Incidentally, in the first embodiment of the invention, although the description has been given to the case of application to the MFP, the scanner 2A can also be applied to a single image reading apparatus. Further, it can be applied also to a document size detecting apparatus to detect the size of the document M without performing the image reading.

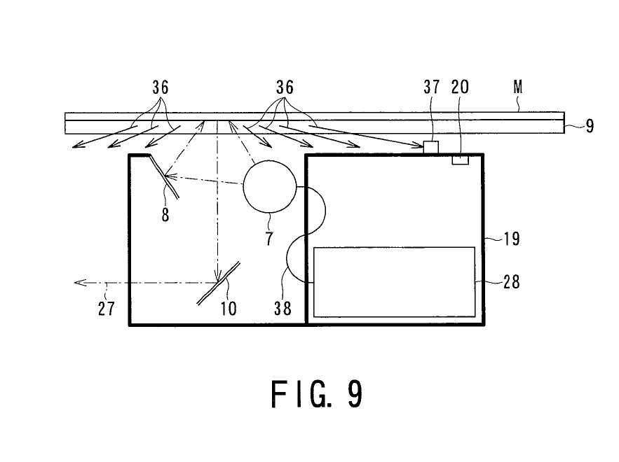

Further, as shown in FIG. 9 described later, in the case where a high-intensity lamp is used as the light source 7, in view of a possibility that a part of a scattered light 36 reflected by the document M and scattered is incident on the light-receiving APS sensor 20, the scattered light may be physically shielded. Hereinafter, a supplemental explanation will be made with reference to FIG. 9.

FIG. 9 is a view showing a structure of the first carriage 19 in which a light shielding unit 37 to shield the light (hereinafter referred to as the scattered light) 36, which is irradiated at the time of image reading to the periphery of the light-receiving APS sensor 20 and is reflected and scattered by the document M, is placed in the scanner 2A of the MFP 1A.

As shown in FIG. 9, by providing the light shielding unit 37 to shield the light between the scattered light 36 and the light-receiving APS sensor 20 in the first carriage 19, part of the scattered light 36 reflected and scattered by the document M can be prevented from entering the light-receiving APS sensor 20, and the erroneous detection of the document size can be prevented. Incidentally, numerical reference 38 shown in FIG. 9 denotes a connector to electrically connect the inverter 28 and the light source 7.

### Second Embodiment

Although an MFP of a second embodiment of the invention is different from the MFP of the first embodiment in that the positional relation between the document presence/absence detecting light-emitting element 35 and the document size detecting light-emitting elements (light-emitting APS sensors 17) to emit lights at the time of detection of the presence/absence of the document and the size, and the document size detecting light-receiving elements and the document presence/absence detecting light-receiving elements (light-receiving APS sensors 20) is reversed, they are not substantially different from each other in other points. Then, structural elements not substantially different from those of the MFP of the first embodiment of the invention are denoted by the same symbols in the drawings and their description will be omitted.

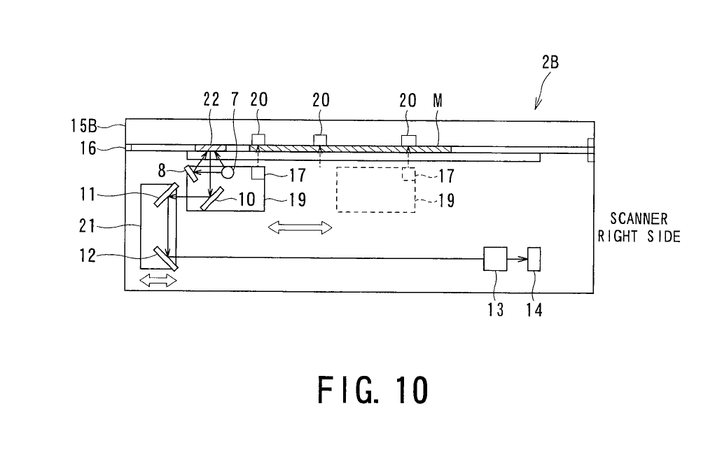

FIG. 10 is a view schematically showing a structure of a scanner 2B as an example of a scanner of the MFP of the second embodiment of the invention.

The scanner (image reading apparatus) 2B irradiates a document M positioned on a document table glass 9 with a light irradiated from a light source (for example, xenon lamp) 7 and a light irradiated from the light source 7 and reflected by a reflector 8, and the reflected light is condensed by a condensing lens 13 through a first mirror 10, a second mirror 11, and a third mirror 12 and is imaged onto a CCD sensor 14.

The document M is fixed on the document table glass 9 by a document table cover (platen cover) 15B. The open/close state of the platen cover 15B is detected by ON/OFF of a platen cover open/close switch 16. Further, light-receiving APS sensors 20 are arranged at specified positions on the rear (document table glass 9) side in the platen cover 15B.

The xenon lamp 7 as an example of a light source, an inverter (not shown in FIG. 10) to drive the xenon lamp 7, the reflector 8, and the first mirror 10 are arranged in a first carriage 19. Further, light-emitting APS sensors 17 are arranged in the first carriage 19.

Incidentally, in the image reading apparatus shown in FIG. 10, there is also a case where instead of the platen cover 15B, a not-shown automatic document feeder (ADF) is mounted and an image of a document is read from the ADF.

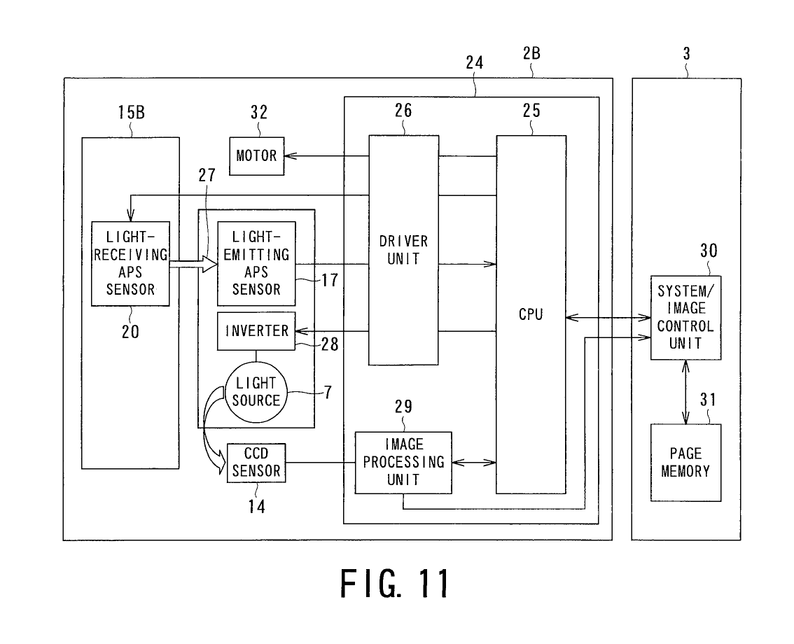

FIG. 11 is a functional block diagram of an MFP 1B.

As shown in FIG. 11, a difference between the MFP 1B and the MFP 1A is the direction of a light 27, and the other points are not substantially different from each other.

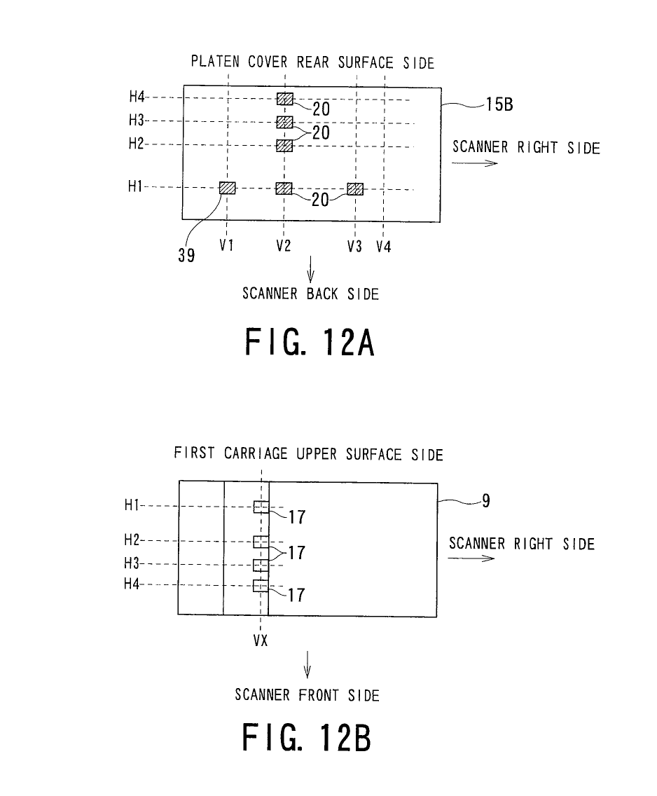

FIG. 12A and FIG. 12B are views showing an example in which document size detecting light-emitting elements, document presence/absence detecting light-emitting elements, document size detecting light-receiving elements and a document presence/absence detecting light-receiving element are mounted in the MFP 1B.

In more detail, FIG. 12A is an arrangement view of light-receiving APS sensors 20 as document size detecting light-receiving elements and a document presence/absence detecting light-receiving element 39 seen from the rear side of the platen cover 15B, and FIG. 12B is an arrangement view of light-emitting APS sensors 17 as the document size detecting light-emitting elements and the document presence/absence detecting light-emitting elements as seen from the upper (document table glass 9) side.

As shown in FIG. 12A, the light-receiving APS sensors 20 are arranged at V2H1, V2H2, V2H3, V2H4 and V3H1 on the rear side of the platen cover 15. Further, the document presence/absence detecting light-receiving element 39 to receive the light at the time of document detection is arranged at a position of V1H1.

In the MFP 1B, transmission sensors are used as the light-receiving APS sensors 20 and the document presence/absence detecting light-receiving element 39. Accordingly, the light-receiving element 39 at V1H1 shown in FIG. 12A and the light-emitting element 17 at VXH1 shown in FIG. 12B, the light-receiving elements 20 at V2H1, V2H2, V2H3 and V2H4 shown in FIG. 12A and the light-emitting elements 17 at VXH1, VXH2, VXH3 and VXH4 shown in FIG. 12B, and the light-receiving element 20 at V3H1 of FIG. 12A and the light-emitting element 17 at VXH1 shown in FIG. 12B are paired with each other.

Since all of the light-emitting APS sensors 17, the light-receiving APS sensors 20 and the document presence/absence detecting light-receiving element 39 are transmission sensors, unlike the reflection sensor, even if the document M as the reading object of an image has a high density, erroneous detection does not occur, and the presence/absence of the document M and the size can be certainly detected.

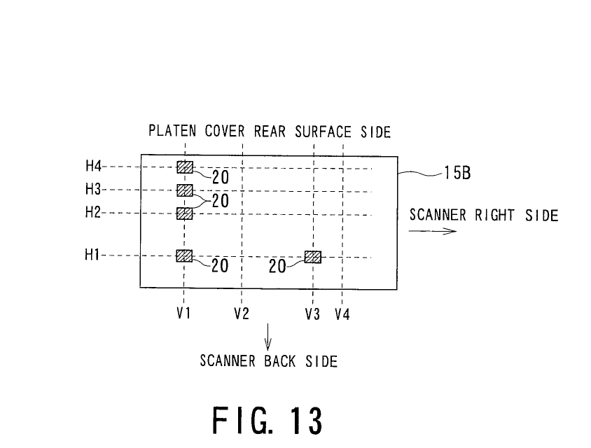

FIG. 13 is a view showing another example (different from the example shown in FIG. 12A) in which the document size detecting elements and the document presence/absence detecting elements are mounted in the MFP 1B, and is more particularly an arrangement view of the light-receiving APS sensors 20 seen from the rear side of the platen cover 15B.

Incidentally, in the another example shown in FIG. 13, the mounting example shown in FIG. 12B is applied to the mounting of the document size detecting light-receiving elements and the document presence/absence detecting light-receiving element.

As shown in FIG. 13, the light-receiving APS sensors 20 to receive the lights are arranged at positions of V1H1, V1H2, V1H3 and V1H4 and a position of V3H1 on the rear side of the platen cover 15B.

A difference between the mounting example shown in FIG. 13 and the mounting example shown in FIG. 12A is that in the platen cover 15B shown in FIG. 13, the document presence/absence detecting light-receiving element 39 is not provided, and the positions where the light-receiving APS sensors 20 are arranged are changed.

In the platen cover 15B, by arranging the light-receiving APS sensors 20 at positions shown in FIG. 13, when the first carriage 19 in which the light-emitting APS sensors 17 are provided is at a stand-by position (home position), the breadth (length in the main scanning direction) of the document M can be detected by the light-receiving APS sensors 20 at V1H1, V1H2, V1H3 and V1H4 and the light-emitting APS sensors 17 at VXH1, VXH2, VXH3 and VXH4 shown in FIG. 12B.

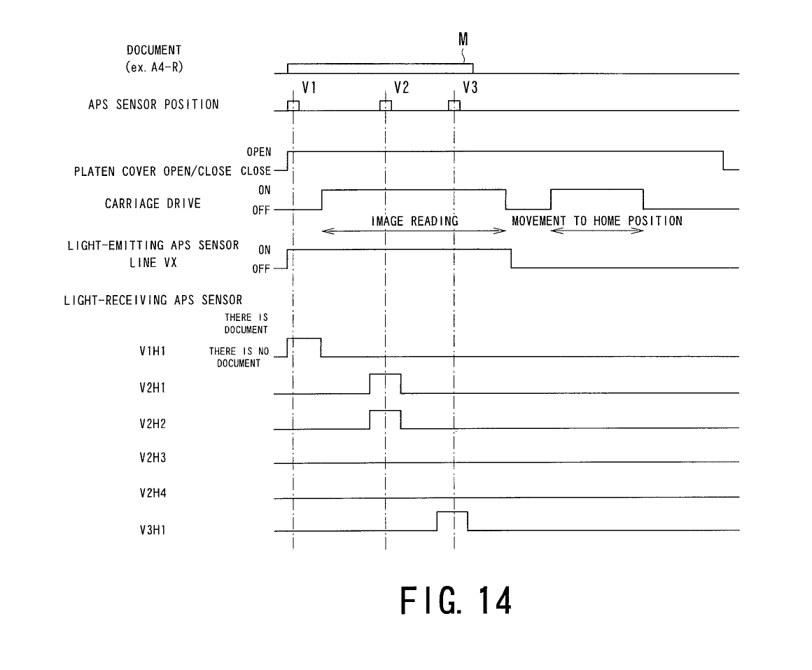

FIG. 14 is a view showing a timing chart of document size detection in the MFP 1B in which the horizontal axis is a time axis.

In FIG. 14, the description will be given to the case where the document M of A4-R size is placed on the document table glass 9, and the platen cover 15B has the structure shown in FIG. 12A.

When the user positions the document M on the document table glass 9 and closes the platen cover 15B, all the light-emitting APS sensors 17 at positions of VX emit lights in order to detect the presence/absence of the document M. The emitted light is first received by the document presence/absence detecting light-receiving element 39 at the position of V1H1.

When the document presence/absence detecting light-receiving element 39 receives the light emitted from the light-emitting APS sensor 17, the CPU 25 detects the presence/absence of the document M based on the received light. In the case where the CPU 25 judges that the document M does not exist, a subsequent processing (APS processing) is not carried out.

The detection of the size of the document M is performed by the CPU 25 based on the detection result of the light-receiving APS sensors 20A to 20E arranged at the positions of V2H1, V2H2, V2H3, V2H4 and V3H1 according to the document size when the carriages 19 and 21 are operated by the start of reading of the document M.

In the case where among the light-receiving APS sensors 20, the light-receiving APS sensors 20 arranged at the positions of V2H1, V2H2 and V3H1 detect the document M (there is no received light), and the light-receiving APS sensors 20 arranged at the positions of V2H3 and V2H4 do not detect the document M (there is received light), the document size is recognized to be A4-R.

The size of the document M can be judged by the number of times that the light-receiving APS sensors 20 detect the document M by movement (scanning) of the light-emitting APS sensors 17.

When the image reading is completed, the first carriage 19 and the second carriage 21 are moved to the home position.

In the MFP 1B, since the transmission sensor is adopted as the sensor to detect the presence/absence of the document M and the size, the apparatus can be made thinner than the case where the reflection sensor is adopted, and even if the document M as the reading object of an image has a high density, erroneous detection does not occur, and the presence/absence of the document M and the size can be certainly detected.

Further, the presence/absence of the document M can be detected by using the light-receiving element and the light-emitting element for the size detection of the document M and without providing the sensor (document presence/absence detecting light-receiving element 39) to detect the presence/absence of the document M (see FIG. 13). Further, forgetting to take the document M can also be detected.

On the other hand, the image reading is carried out after the detection of the document size, document size information is transmitted to the printer 3 before the image reading termination (completion of writing into a page memory 31), and the selection of a suitable paper size can be carried out at the printer 3 side.

Further, since there is no problem when the light emitting ASP sensors 17 are always turned on during the document reading operation, it is unnecessary to perform the light emitting ASP sensor 17, which can contribute to the reduction of processing in the controller.

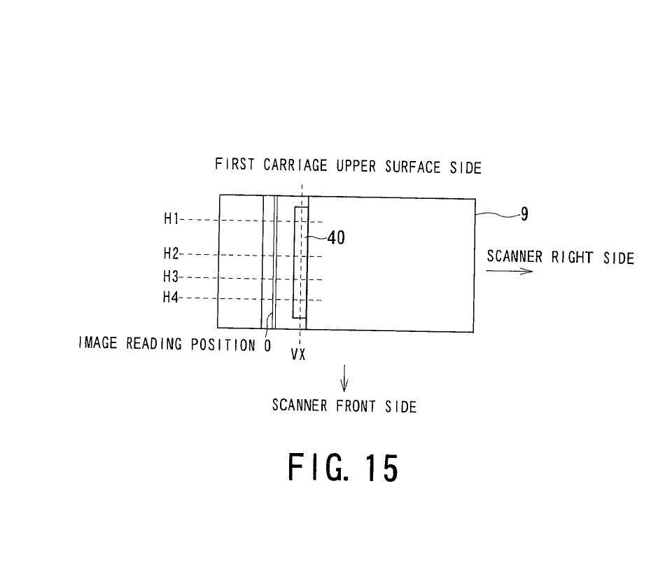

Incidentally, although the description has been given to the case where in the MFP 1B, as shown in FIG. 12B, the light-emitting APS sensors 17 provided in the first carriage 19 are point light sources, as shown in FIG. 15, there is also a case of a line light source 40. In the case where the document size detecting light-emitting element is the line light source 40, since the light source 7 to expose the document M is arranged in the first carriage 19, the light of the light source 7 may be used for the detection of the document size.

In addition, in the second embodiment of the invention, although the description has been given to the case of application to the MFP, the scanner 2B can also be applied to a single image reading apparatus. Further, it can be applied also to a document size detecting apparatus which detects the size of the document M without performing image reading.

### Third Embodiment

An MFP of a third embodiment of the invention is constructed by further adding, to the MFP 1A, a function (hereinafter referred to as a document inclination detecting function) to detect that the document M is obliquely placed on the document table glass 9 in a case where the document M is obliquely positioned.

In the MFP of the third embodiment of the invention, since the document inclination detecting function is further added to the MFP 1A, the structure of the control device 24 in the scanner 2A shown in FIG. 3 is different. In the description of this embodiment, with respect to structural elements substantially not different from those of the MFP 1A, their description will be omitted.

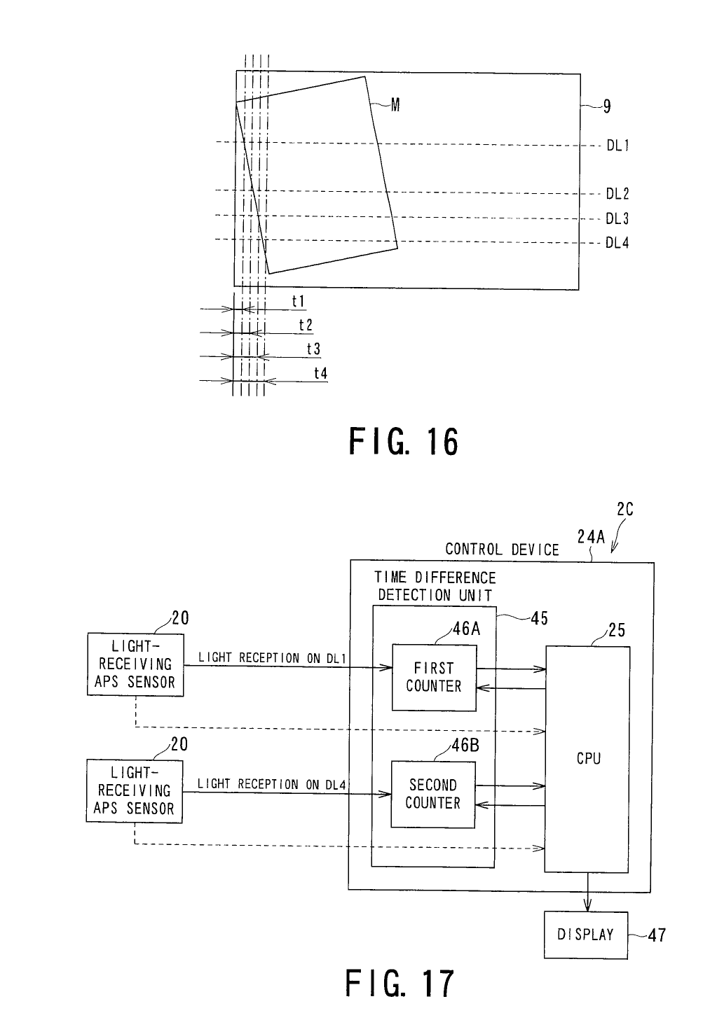

FIG. 16 is a view for explaining how to detect the inclination of the document M in 2C as an example of a scanner of the MFP of the third embodiment of the invention.

As shown in FIG. 16, when the image of the document M is read in the state where the document M is obliquely placed on the document table glass 9, the scanner 2C reads the image of the document M as an oblique image. Accordingly, when the read image is printed, the oblique image is printed, and a misprint occurs.

When it can be detected before the execution of reading of the image that the document M is obliquely placed, the disadvantage, that is, the misprint does not occur. Then, in the scanner 2C, for example, four sensors (hereinafter referred to as document size detecting elements) each capable of detecting the document size, such as an APS sensor (the pair of the light-emitting APS sensor 17 and the light-receiving APS sensor 20), are arranged in the main scanning direction, and at least two sensors (for example, the first document size detecting element and the fourth document size detecting element) are used to detect the inclination of the document M.

Here, DL1 to DL4 shown in FIG. 16 denote lines on which the first document size detecting element to the fourth document size detecting element can detect the document M.

For example, a time t1 from the reading operation start time to the time when the first document size detecting element detects the document M on DL1, and a time t4 from the reading operation start time to the time when the fourth document size detecting element detects the document M on DL4 are obtained, and in the case of t4−t1>T(>0), it is possible to judge that the document M is obliquely placed. Here, T denotes an arbitrary time difference for the judgment that the image is inclined.

FIG. 17 is a view schematically showing a structural example of a control device 24A in 2C as the example of the scanner of the MFP of the third embodiment of the invention.

Although the control device 24A in the MFP 1C to detect the inclination of the document M further includes a time difference detection unit 45 as compared with the MFP 1A, the other points are not substantially different. Then, a driver unit 26 and an image processing unit 29 as structural elements not substantially different are omitted in view of simplification of the drawing.

The control device 24A includes a first counter 46A to measure the time t1 from the reading operation start time to the time when the first document size detecting element detects the document M on DL1, and a second counter 46B to measure the time t4 from the reading operation start time to the time t4 when the fourth document size detecting element detects the document M on DL4.

The first counter 46A and the second counter 46B start counting in synchronization with the image reading operation start. Thereafter, when the document M is detected, the first counter 46A and the second counter 46B finish the counting and output the count value to the CPU 25.

The CPU 25 carries out an operation to obtain a detection time difference (difference of the count value) of the light-receiving APS sensors 20 based on the count value received from the first counter 46A and the count value received from the second counter 46B.

In the case where the detection time difference (difference of the count value) of the light-receiving APS sensors 20 exceeds a previously set threshold T, that is, in the case of t4−t1>T(>0), the CPU 25 judges that the document M is obliquely placed, and controls the scanner 2C to stop the image reading operation. Alternatively, it is displayed on a display 47 of a control panel or the like that the document M is obliquely placed.

In the MFP 1C, even if the document M is obliquely positioned, the image reading operation is stopped, or that point is notified to the user before the image reading, and therefore, it is possible to prevent the image of the document M from being read in the state where it is obliquely placed. Further, since the image is prevented from being read when it is the oblique image, it is possible to prevent a misprint from occurring when the read image is printed.

Incidentally, although it has been described that the detection of the time difference (difference of the count value) of the light-receiving APS sensors 20 is performed by the time difference detection unit 45, as indicated by dotted lines of FIG. 17, the control device 24A may be configured such that the CPU 25 directly receives the time from the reading operation start time to the detection of the document M in the two document size detecting elements and calculates the time difference.

Further, although the description has been made such that the measurement of the time difference till the two different document size detecting elements detect the document M is performed by obtaining the difference of the times required till the detection on the basis of the reading operation start time, it may be performed such that the detection time of the document size detecting element having detected the document M first is made the reference, and the time delay till the other document size detecting element detects the document M is measured.

Furthermore, in this embodiment, although the description has been given to the case of application to the MFP, the scanner 2C can also be applied to a single image reading apparatus. Further, it can be applied also to a document size detecting apparatus to detect the size of the document M without performing the image reading.

According to the invention, since the document size can be detected before the reading of the document, the document size detection and the image reading can be performed at the same time, and the document reading can be ended with the size suitable to the document size. Accordingly, the document reading time can be shortened.

Further, by providing the plural light-emitting elements in the carriage and by providing the plural light-receiving elements on the platen cover side, unlike the conventional image reading apparatus, it becomes unnecessary to provide a document size detecting element on the scanner base metal plate, and therefore, it becomes possible to reduce the size and thickness of the apparatus.

Furthermore, by using the transmission sensor, it becomes possible to detect the document size of a high density document which can not be suitably detected by the reflection sensor.

In addition, the document size detecting light-emitting element is made the line light source from the solid scan element, so that it becomes possible to use the light source 7 used for reading of the image, which contributes to the reduction in cost of the apparatus.

Since the inclination of the document M positioned on the document table glass 9 can be detected by using the fixed document size detection element (light receiving side) before the image reading completion of the document M, it is possible to prevent the document M from being read as an oblique image.

Further, when the structure is made such that the CPU 25 performs an arithmetical operation on the detection result of the document size detecting light-receiving elements in order to detect the inclination of the document M on the document table glass 9, the counter 46 (the first counter 46A and the second counter 46B) becomes unnecessary.

Furthermore, since the control device 24, 24A performs ON/OFF control so that the document size detecting light-emitting element (light-emitting APS sensor 17) does not emit light at a time except the document size detection time, and accordingly, the irradiation light from the light-emitting APS sensor 17 can be prevented from entering the read image as the external disturbance light, and the erroneous detection of the document size and the degradation in picture quality of the read image can be prevented.

Still further, by providing the light shielding unit 37 to shield the light between the scattered light 36 and the light-receiving APS sensor 20 in the first carriage 19, the scattered light 36 can be prevented from entering the light-receiving APS sensor 20, and the erroneous detection of the document size and the degradation in picture quality of the reading image can be prevented.

Since the presence/absence of the document M can be detected while the first carriage 19 is at the standby position (home position), the presence/absence of the document M can be detected in the state where the platen covers 15A, 15B is closed. As a result, it is possible to prevent the forgetting to take the document M after the image reading.

Besides, since the breadth of the document M can be detected while the first carriage 19 is at the standby position (home position), the unnecessary light-emitting APS sensor 17 can be turned off at the image reading time of the document M. As a result, it is possible to prevent the degradation of picture quality of the read image due to the light emission of the light-emitting APS sensor 17 at the time of image reading.

In the case where the document size is detected, the reading operation is stopped, and the carriage is returned to the standby position, so that the reading time can be shortened. Further, since the image reading of the document M and the document size detection can be performed by the same scan, pre-scan for document size detection becomes unnecessary, and the number of sheets of image reading per an arbitrary time and the number of sheets of image copy can be improved (productivity is improved). That is, it becomes possible to provide the image reading apparatus and the MFP in which higher productivity is obtained, the degradation in picture quality does not occur, and the reading miss does not occur.

Incidentally, the invention is not limited to the respective embodiments as they are, and at the practical stage, the structural elements can be modified and embodied within the scope not departing from the gist. Further, various inventions can be formed by suitable combinations of plural structural elements disclosed in the respective embodiments. For example, some structural elements may be deleted from all the structural elements disclosed in the embodiment. Besides, the structural elements of different embodiments may be suitably combined.

What is claimed is:

1. An MFP comprising:
a scanner to read an image; and
a printer to form the image on a sheet,
wherein the scanner includes:
a document table on which a document as an image reading object is placed;
a platen cover that holds the document to the document table;
a carriage that moves along the document table;
a document size detecting element that detects a size of the document at a position in front of an image reading start position of the document in an image reading direction; and
a control device that detects the document size based on an output of the document size detecting element.

2. The MFP according to claim 1, wherein said document size detecting element is a pair of a document size detecting light-emitting element that emits light at a time of detection of the document size and a document size detecting light-receiving element that receives the irradiation light from the document size detecting light-emitting element,
said document size detecting light-emitting element is placed at the document surface side of the carriage, and
said document size detecting light-receiving element is placed at the document surface side of the platen cover.

3. The MFP according to claim 2, wherein said document size detecting light-emitting element is a line light source.

4. The MFP according to claim 1, wherein said document size detecting element is a pair of a document size detecting light-emitting element that emits light at a time of detection of the document size and a document size detecting light-receiving element that receives the irradiation light from the document size detecting light-emitting element,
said document size detecting light-emitting element is placed at the document surface side of the platen cover, and
said document size detecting light-receiving element is placed at the document surface side of the carriage.

5. The MFP according to claim 1, wherein said document size detecting element is a pair of a document size detecting light-emitting element that emits light at a time of detection of the document size and a document size detecting light-receiving element that receives the irradiation light from the document size detecting light-emitting element, and
said control device performs ON/OFF control of timing when the document size detecting light-emitting element emits light in synchronization with scanning of the carriage.

6. The MFP according to claim 5, wherein said control device performs ON/OFF control to cause the document size detecting light-emitting element to emit light in a specified range before and after the document size detecting light-emitting element relatively passes through the document size detecting light-receiving element as the carriage is scanned.

7. The MFP according to claim 1, wherein said carriage further includes a light shielding unit which shields light so that the document size detecting element prevents from receiving a scattered light from the document.

8. The MFP according to claim 1, wherein said control device includes a document presence/absence detection unit that detects whether the document is placed on the document stand in a state where the carriage is at a specified position.

9. The MFP according to claim 8, wherein said control device performs a control to detect whether the document is placed on the document table and to detect the size of the document in synchronization with scanning of the carriage.

10. The MFP according to claim 1, wherein said control device detects the size of the document in a main scanning direction in a state where the carriage is at a specified position.

11. The MFP according to claim 1, wherein said control device includes a document inclination detection unit to judge whether the document is inclined based on times when at least two of the different document size detecting elements detect an end of the document.

12. The MFP according to claim 11, wherein said control device stops image reading and notifies that the document is obliquely placed on the document table in a case where the document inclination detection unit detects inclination of the document.

13. An image reading apparatus comprising:
a document table on which a document as an image reading object is placed;
a platen cover that holds the document to the document table;
a carriage that moves along the document table;
a document size detecting element that detects a size of the document at a position in front of an image reading start position of the document in an image reading direction; and
a control device that detects the document size based on an output of the document size detecting element.

14. The image reading apparatus according to claim 13, wherein said document size detecting element is a pair of a document size detecting light-emitting element that emits light at a time of detection of the document size and a document size detecting light-receiving element that receives the irradiation light from the document size detecting light-emitting element,
said document size detecting light-emitting element is placed at the document surface side of the carriage, and
said document size detecting light-receiving element is placed at the document surface side of the platen cover.

15. The image reading apparatus according to claim 14, wherein said document size detecting light-emitting element is a line light source.

16. The image reading apparatus according to claim 13, wherein said document size detecting element is a pair of a document size detecting light-emitting element that emits light at a time of detection of the document size and a document size detecting light-receiving element that receives the irradiation light from the document size detecting light-emitting element,
said document size detecting light-emitting element is placed at the document surface side of the platen cover, and
said document size detecting light-receiving element is placed at the document surface side of the carriage.

17. The image reading apparatus according to claim 13, wherein said document size detecting element is a pair of a document size detecting light-emitting element that emits light at a time of detection of the document size and a document size detecting light-receiving element that receives the irradiation light from the document size detecting light-emitting element, and
said control device performs ON/OFF control of timing when the document size detecting light-emitting element emits light in synchronization with scanning of the carriage.

18. The image reading apparatus according to claim 17, wherein said control device performs ON/OFF control to cause the document size detecting light-emitting element to emit light in a specified range before and after the document size detecting light-emitting element relatively passes through the document size detecting light-receiving element as the carriage is scanned.

19. The image reading apparatus according to claim 13, wherein the carriage further includes a light shielding unit which shields light so that the document size detecting element prevents from receiving a scattered light from the document.

20. The image reading apparatus according to claim 13, wherein said control device includes a document presence/absence detection unit that detects whether the document is placed on the document stand in a state where the carriage is at a specified position.

21. The image reading apparatus according to claim 20, wherein said control device performs a control to detect whether the document is placed on the document table and to detect the size of the document in synchronization with scanning of the carriage.

22. The image reading apparatus according to claim 13, wherein said control device detects the size of the document in a main scanning direction in a state where the carriage is at a specified position.

23. The image reading apparatus according to claim 13, wherein said control device includes a document inclination detection unit to judge whether the document is inclined based on times when at least two of the different document size detecting elements detect an end of the document.

24. The image reading apparatus according to claim 23, wherein said control device stops image reading and notifies that the document is obliquely placed on the document table in a case where the document inclination detection unit detects inclination of the document.

25. A document detecting method comprising the steps of:
detecting whether a document is placed on a document table; and
detecting a size of the document,
wherein said document presence/absence detection step and the document size detection step are performed before image reading when a carriage is moved to perform the image reading of the document.

26. The document detecting method according to claim 25, further comprising the steps of:
measuring a time when the document is detected at least two different places in a main scanning direction, and
detecting an inclination of the document based on at least two time differences measured in the document detection time measurement step.

27. The document detecting method according to claim 26, further including at least one step of: an image reading stop step in which image reading of the document is stopped; and a placed document inclination notification step in which it is notified to a user that the document is placed on the document table in the state where the document is inclined, in a case where it is detected in the document inclination detection step that the document is placed on the document table in a state where the document is inclined.

28. The document detecting method according to claim 25, wherein said document presence/absence detection step and said document size detection step are carried out simultaneously.
